(19) United States
(12) Patent Application Publication
(10) Pub. No.: US 2002/0080327 A1
(43) Pub. Date: Jun. 27, 2002

(54) Tinted contact lenses

(76) Inventors: Douglas G. Clark, Jacksonville, FL (US); Khaled A. Chehab, Jacksonville, FL (US); Sheila Hickson-Curran, Ponte Vedra Beach, FL (US); Karin D. McCarthy, Ponte Vedra Beach, FL (US)

Correspondence Address: Philip S. Johnson, Esq., Johnson & Johnson, One Johnson & Johnson Plaza, New Brunswick, NJ, 08933-7003, US

(21) Appl. No.: 09/745,511

(22) Filed: Dec. 22, 2000

(51) Int. Cl. G02C 7/04

(52) U.S. Cl. 351/162; 351/160 R

(57) ABSTRACT

The invention provides tinted contact lenses, and methods for their manufacture, that alter the natural color of the lens wearer's iris. The lenses use a base layer of translucent color having a clear central zone and a translucent color zone in combination with one or more layers of translucent color, one or more layers of opaque color, or a combination thereof, each of which additional zones has a clear central zone and a zone of color.

### FIELD OF THE INVENTION

The invention relates to tinted contact lenses. In particular, the invention provides contact lenses that change the natural color of the lens wearer's iris.

### BACKGROUND OF THE INVENTION

The use of tinted, or colored, contact lenses to alter the natural color of the iris is well known. In some of these lenses, translucent color is used which covers the pupil aperture and iris. This minimizes the difference between the high light absorbing iris zone and the pupil zone. However, this design results in an overall reduction of the light reaching the retina. In other lenses, opaque shapes are used only over the iris permitting a portion of the natural iris to be seen. A disadvantage of these lenses is that the visual filed is restricted, especially under low illumination, by blurring or hazing in the peripheral visual field. Thus, a need exists for a contact lens that alters the natural color of the iris, but that overcomes some of these disadvantages.

### BRIEF DESCRIPTION OF THE DRAWINGS

FIG. 1 is a scanned image of a plan view of a base translucent color layer of the invention.

FIG. 2 is a scanned image of a plan view of a first opaque color layer of the invention.

FIG. 3 is a scanned image of a plan view of a second opaque color layer of the invention.

FIG. 4 is a scanned image of a plan view of an embodiment of a surface of a lens of the invention incorporating the color layers of FIGS. 1 through 3.

FIG. 5 is a scanned image of a plan view of a base translucent color layer of the invention.

FIG. 6 is a scanned image of a plan view of an opaque color layer of the invention.

FIG. 7 is a scanned image of a plan view of a second translucent color layer of the invention.

FIG. 8 is a scanned image of a plan view of an embodiment of a surface of a lens of the invention incorporating the color layers of FIGS. 5 through 7.

FIG. 9 is a scanned image of a plan view of a base translucent color layer of the invention.

FIG. 10 is a scanned image of a plan view of a second translucent color layer of the invention.

FIG. 11 is a scanned image of a plan view of an opaque color layer of the invention.

FIG. 12 is a scanned image of a plan view of an embodiment of a surface of a lens of the invention incorporating the color layers of FIGS. 9 through 11.

FIG. 13 is a scanned image of a plan view of a base translucent color layer of the invention.

FIG. 14 is a scanned image of a plan view of a second translucent color layer of the invention.

FIG. 15 is a scanned image of a plan view of an opaque color layer of the invention.

FIG. 16 is a scanned image of a plan view of an embodiment of a surface of a lens of the invention incorporating the color layers of FIGS. 12 through 16.

### DETAILED DESCRIPTION OF THE INVENTION AND PREFERRED EMBODIMENTS

The invention provides tinted contact lenses, and methods for their manufacture, that alter the natural color of the lens wearer's iris. The lenses of the invention provide a natural appearing iris and, at the same time, good peripheral and overall vision under all lighting conditions. It is a discovery of the invention that these characteristics can be achieved in a tinted lens by the use of a base layer of translucent color, the base layer having a clear central zone and a translucent color zone, in combination with one or more layers of translucent color, one or more layers of opaque color, or a combination thereof, each of which additional zones has a clear central zone and a zone of color.

In one embodiment, the invention provides at least one surface of a contact lens comprising a base layer having a clear central zone and a translucent color zone and one or more additional color layers selected from the group consisting of a second translucent color layer, an opaque color layer, or a combination thereof, each of the additional color layers comprising a clear central zone and a color zone. For purposes of the invention, by “translucent” is meant a color that permits an average light transmittance ( % T) in the 380 to 780 nm range of greater than or equal to about 60, preferably greater than or equal to about 65 percent T. By “opaque” is meant a color that permits an average light transmittance (% T) in the 380 to 780 nm range of 0 to about 55, preferably 7 to about 50 percent T.

The color layers may be applied to either the back, or eye side, surface or the front, or object side, surface of the lens, or combinations thereof, but preferably all of the layers are on the front surface of the lens. Additionally, the layers may be applied, or printed, in any order. For example, the base layer may be applied behind a translucent and opaque layer or between one or more opaque layers. Preferably, the base layer is the outermost color layer on the surface of the lens. In yet another embodiment, a clear, pre-polymer layer may be used in conjunction with the color layers. One ordinarily skilled in the art will appreciate that any of a number of embodiments of the lenses of the invention are possible.

The color selected for each of the layers will be determined by the natural color of the lens wearer's iris and the color to which the natural color is to be changed. Thus, the base layer may be any color including, without limitation, any of a variety of hues and chromas of blue, green, gray, brown, yellow, red, or combinations thereof The additional translucent layer or layers may be any color that complements the base layer color or is a shift of that color in terms of one or more of hue, chroma, and lightness. The opaque layer or layers may be any of these colors as well as white or black.

The invention may be used to provide tinted hard or soft contact lenses made of any known lens-forming material, or material suitable for manufacturing such lenses. Preferably, the lenses of the invention are soft contact lenses the material selected for forming the lenses of the invention being any material suitable for producing soft contact lenses. Suitable preferred materials for forming soft contact lenses using the method of the invention include, without limitation, silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof More preferably, the surface is a siloxane, or contains a siloxane functionality, including, without limitation, polydimethyl siloxane macromers, methacryloxypropyl polyalkyl siloxanes, and mixtures thereof, silicone hydrogel or a hydrogel, made of monomers containing hydroxy groups, carboxyl groups, or both or be made from silicone-containing polymers, such as siloxanes, hydrogels, silicone hydrogels, and combinations thereof Materials for making soft contact lenses are well known and commercially available. Preferably, the material is acquafilcon, etafilcon, genfilcon, or lenefilcon.

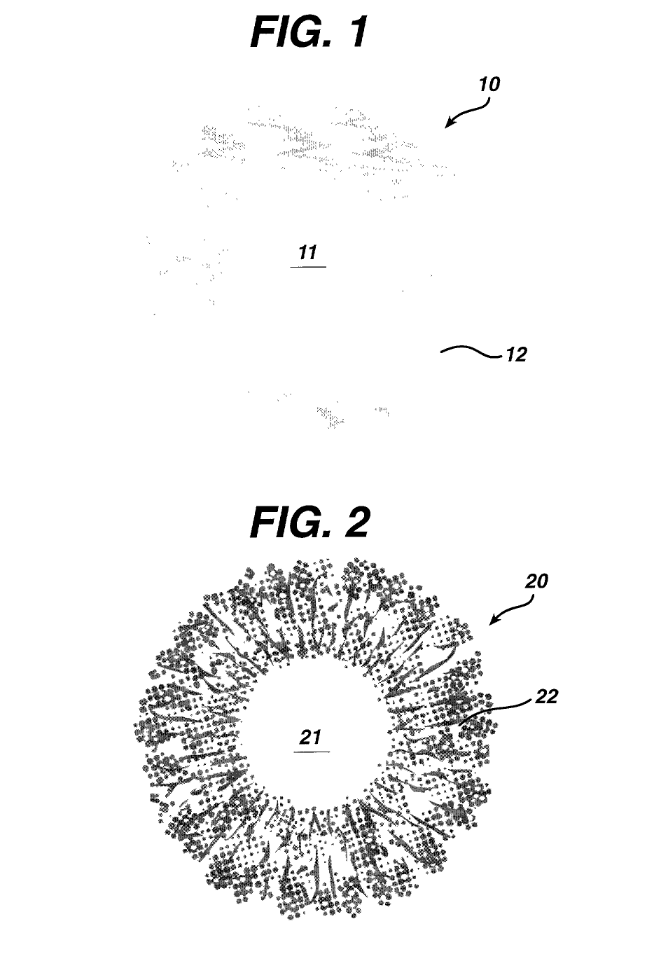

The lenses of the invention contain at least one surface that has a base layer of a first translucent color. In FIG. 1 is depicted base layer 10 for a lens of the invention. Base layer 10 has clear central zone 11 of a diameter such that, when the lens is in it hydrated state, zone 11 is approximately the same or a similar diameter to the lens wearer's pupil, which zone 11 will overlay. Generally, zone 11 will be about 4 to about 6 mm in diameter. Central area 11 is surrounded by translucent color zone 12 that will overlay the lens wearer's iris. Translucent color zone 12 is of a diameter such that, when the lens is in its hydrated state, zone 12 is of the same or similar in diameter to the lens wearer's iris. Typically, zone 12 will be about 10 to about 13 mm in diameter. In the case in which the lens is a hard contact lens, typically only sections 11 and 12 will be present. For soft contact lenses, an additional peripheral zone, not shown in FIG. 1, that is clear may surround zone 12.

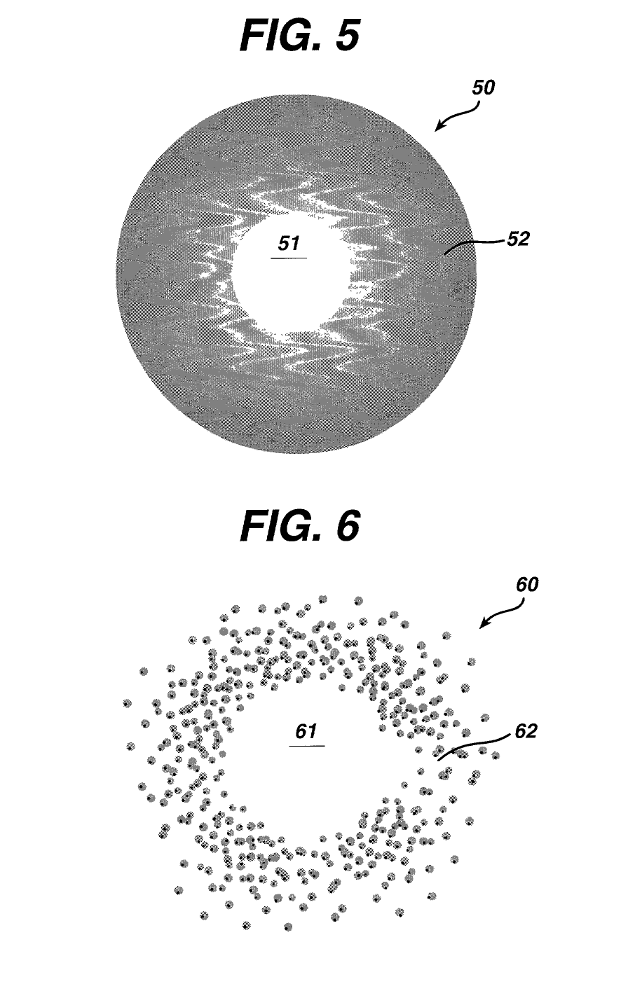

As depicted in FIG. 1, translucent color zone 12 has a uniform color. In FIGS. 5, 9 and 13 are shown alternative base layers in which the translucent color is radially gradient, meaning that the density of the color varies as one moves to the periphery of the color zone. The variation may be one or both of an increase or a decrease in color density. As yet another alternative, the base layer may contain a plurality of clear areas that may be of any shape including, without limitation, circles, ovals, triangles, lines, striae, feather-like shapes, and the like, and combinations thereof. As still another alternative, the base layer color zone may be composed of colored shapes, such as those listed. The colors to be used in the base layer will be selected depending on the natural color of the lens wearer's iris and the color to which the wearer wishes to change the iris.

The color zones of the translucent base layer, as well as of the opaque and translucent color layers, may be made from any organic or inorganic pigment suitable for use in contact lenses, or combinations of such pigments. The opacity may be controlled by varying the concentration of the pigment and titanium dioxide used, with higher amounts yielding greater opacity. Illustrative organic pigments include, without limitation, pthalocyanine blue, pthalocyanine green, carbazole violet, vat orange #1, and the like and combinations thereof Examples of useful inorganic pigments include, without limitation, iron oxide black, iron oxide brown, iron oxide yellow, iron oxide red, titanium dioxide, and the like, and combinations thereof In addition to these pigments, soluble and non-soluble dyes may be used including, without limitation, dichlorotriazine and vinyl sulfone-based dyes. Useful dyes and pigments are commercially available.

The dye or pigment selected may be combined with one or more of a prepolymer, or binding polymer, and a solvent to form the colorant used to produce the translucent and opaque layers used in the lenses of the invention. The pre-polymer may be any polymer that is capable of dispersing the pigment and any opacifying agent used. Other additives useful in contact lens colorants also may be used. The binding polymers, solvents, and other additives useful in the color layers of the invention are known and either commercially available or methods for their making are known.

In addition to the first base layer, one or more additional color layers are used. The additional layers may be one or more translucent color layers, one or more layers of opaque color, or combinations thereof In preferred embodiments, two opaque color layers or a second translucent color layer and an opaque color layer are used. Each of the additional color layers must be of a color that is the same as, similar to, or complementary to, the color of the base layer and aids in achieving the color change desired for the natural iris.

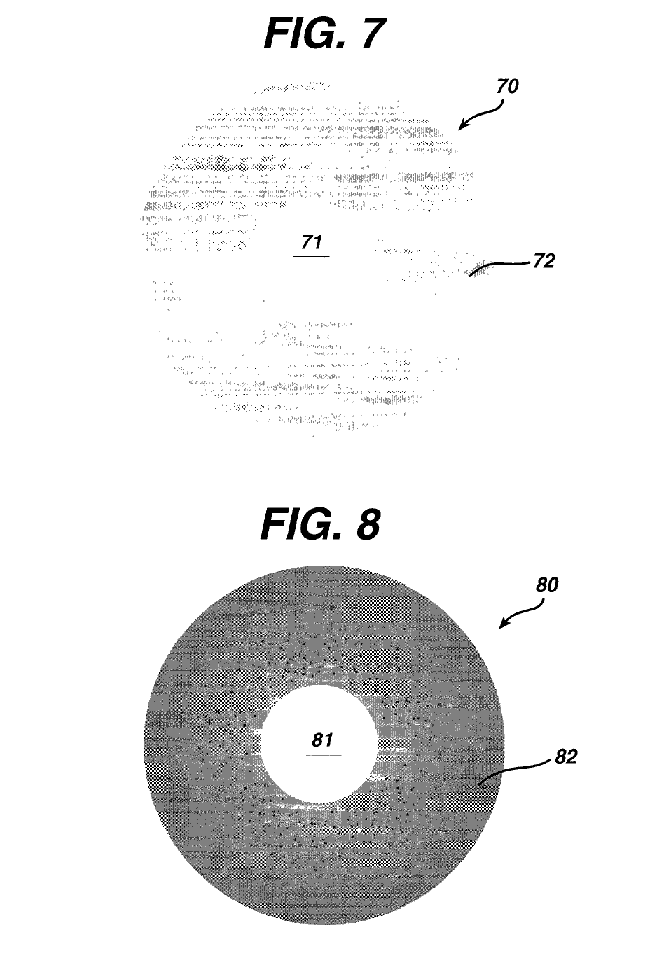

The color zones of the additional translucent color layer or layers may be of a uniform density or radially gradient and may contain any of a number of clear shapes including, without limitation, circles, ovals, triangles, lines, striae, feather-like shapes, and the like, and combinations thereof Alternatively, the color zone may be composed of translucent colored shapes, such as those listed. Exemplary translucent color layers with clear shapes are shown in FIGS. 7 and 14. As an alternative, the translucent color layer may be any of a number of translucent colored shapes as shown in FIG. 10.

One or more layers of opaque color also may be used in the lens of the invention. The color zones of the opaque layer or layers may be uniform or have a radially gradient appearance meaning that, although the opaque color density does not vary, the size, density, and placement of opaquely colored shapes within the zone vary such that a radially gradient effect is produced. The uniform color zones may include clear shapes, the shapes including, without limitation, circles, ovals, triangles, lines, striae, feather-like shapes, and the like, and combinations thereof. Alternatively, the color zone may be composed of opaquely colored shapes, such as those listed.

In FIGS. 1 through 4 are depicted color layers and a surface incorporating the color layers. In FIG. 2 is depicted opaque color layer 20 with central zone 21, a clear zone. Central zone 21 may be the same or a different size than the corresponding zone 11 in the base layer of FIG. 1. Central zone 21 is surrounded by opaque color zone 22 that will overlay zone 12 of the base layer, which zone may be the same size or a different size than that of base layer zone 12. As shown, opaque color zone 22 is composed of a variety of colored shapes. These shapes are depicted as circles and feather-like shapes, but may be of any of a wide variety of shapes. The number, size, and shapes used will be determined by the desired effect to be achieved by the lens and the base and additional opaque or translucent layers used.

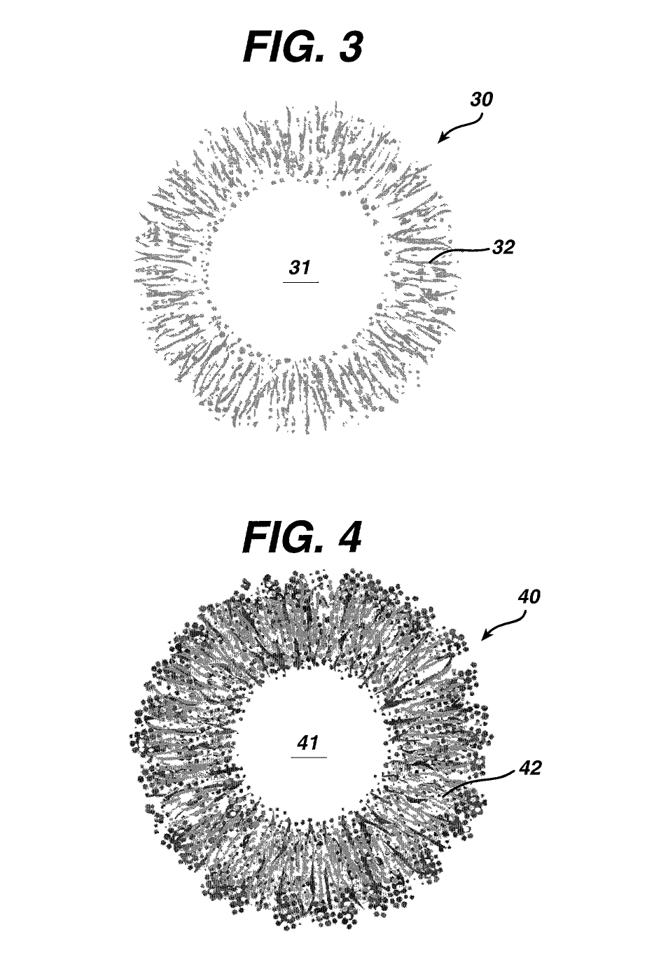

A second opaque color layer 30 is shown in FIG. 3 with central zone 31, a clear zone, that may be of the same or of a different size than zone 21. Central zone 31 is surrounded by opaque color zone 32 that will overlay zone the color zones of the base layer and the other opaque color layer used, which may be the same or a different size than zone 22. As shown, opaque color zone 32 contains a pattern of a plurality of intermittent opaque shapes. These areas aid in imparting depth to the resulting image.

In FIG. 4 is depicted preferred lens surface 40 of the invention. Surface 40 is a depiction of the combination of the base layer of FIG. 1 and the opaque layers of FIGS. 2 and 3 and has clear zone 41 and colored zone 42. Preferably, the base layer is the outermost layer on the lens surface.

In FIG. 8 is depicted surface 80 of a lens of the invention, the color for which is provided by the color layers shown in FIGS. 5 through 7. In FIG. 5 is shown radially gradient base translucent layer 50, containing clear, colorless zone 51 and translucent colored zone 52. In FIG. 6 is depicted opaque color layer 60 having clear area 61 and opaque color zone 62. Color zone 62 is formed of a plurality of opaque circles. In FIG. 7 is a second translucent layer 70, with clear area 71 and uniformly translucent color zone 72 in which there is a plurality of clear, colorless circular voids. In obtaining the colored zone 82 of FIG. 8, the translucent base layer of FIG. 5 was printed first onto a mold, followed by the printing of the opaque layer of FIG. 6 and then the translucent layer of FIG. 7.

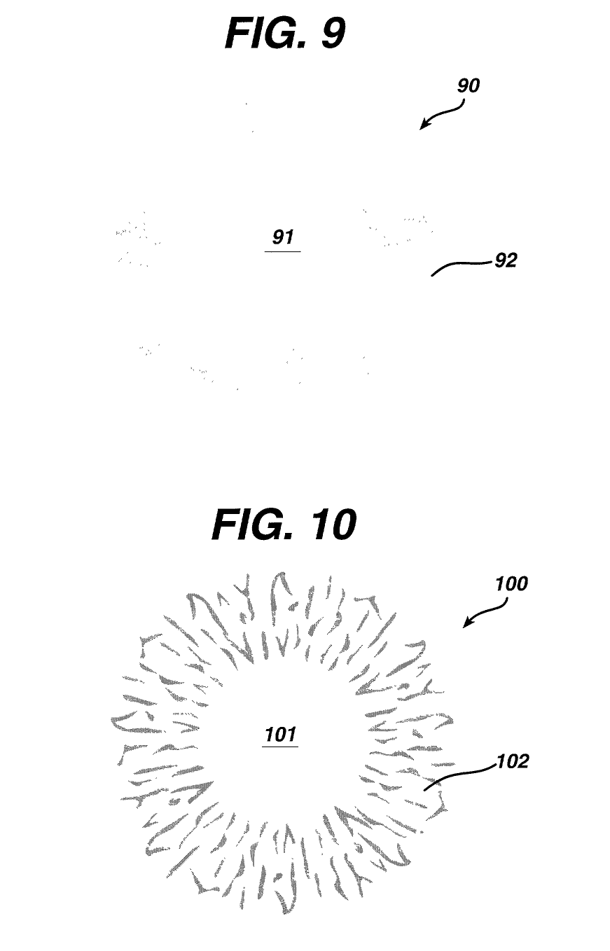

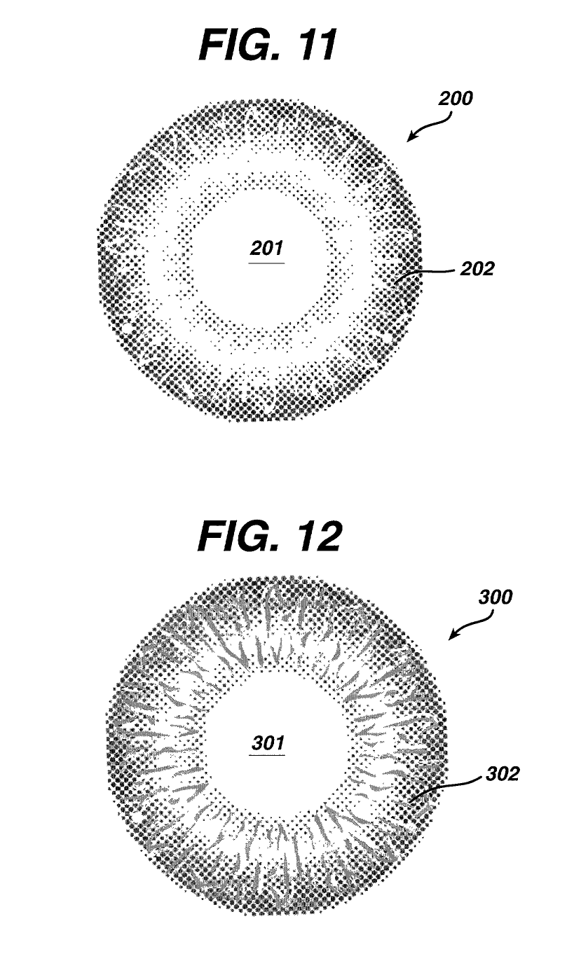

In FIG. 12 is depicted yet another embodiment of a surface 300 of a lens of the invention, the color for which is provided by the color layers shown in FIGS. 9 through 11. In FIG. 9 is shown radially gradient base translucent layer 90, containing central clear zone 91 and translucent colored zone 92. In FIG. 10 is depicted translucent color layer 100 having central clear zone 101 and translucent color zone 102. Translucent color zone 102 is formed of a plurality of translucent, feather-like, shapes. In FIG. 11 is an opaque layer 200, with central clear zone 201 and opaque color zone 202. Opaque zone 202 is composed of a plurality of opaque circles arranged in a radially gradient appearing manner

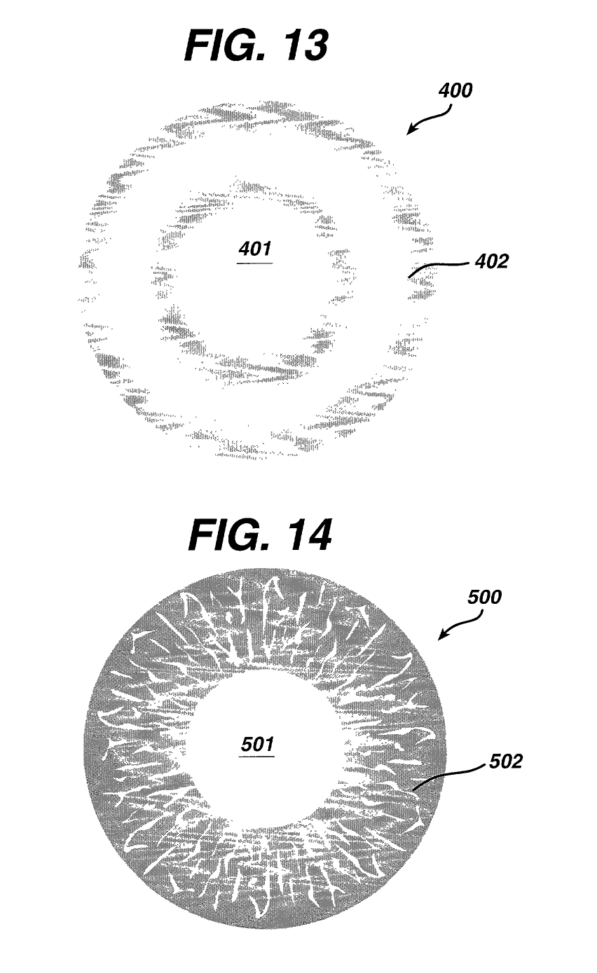

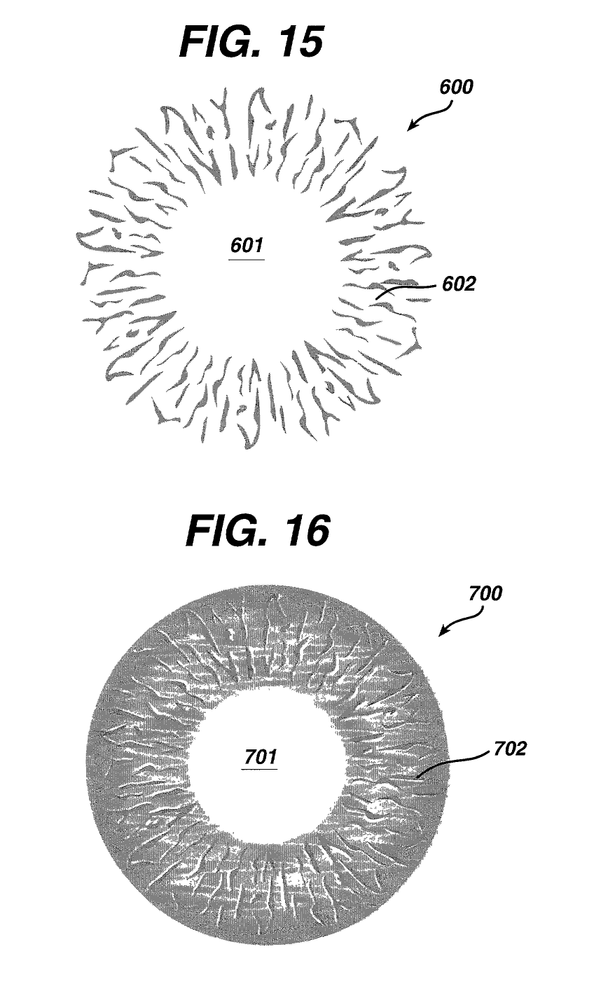

In FIG. 16 is depicted still another embodiment of a surface 700 of a lens of the invention, the color for which is provided by the color layers shown in FIGS. 13 through 15. In FIG. 13 is shown radially gradient base translucent layer 400, containing central clear zone 401 and translucent colored zone 402. In FIG. 14 is depicted radially gradient translucent color layer 500 having central clear zone 501 and translucent color zone 502. Translucent color zone 502 contains a plurality of clear, colorless, feather-like, shapes. In FIG. 15 is opaque layer 600, with central clear zone 601 and opaque color zone 602. Opaque zone 602 is composed of a plurality of opaque, feather-like shapes.

When the lenses of the invention are worn on-eye, greater than about 85%, preferably equal to or greater than about 90%, of the area of the iris is covered the combination of the color zones of all of the color layers used. This is advantageous in that a color change to the iris may be imparted without either blocking the natural iris structure or having an impact on visual performance while providing an appearance of depth within the pattern. Additionally, using the color layers of the invention, even the color of the darkest colored on irises may be changed. The base layer color zone coverage preferably is about 85 to about 99 percent. The total coverage imparted by the color zones of the additional color layers preferably is about 40 to about 70 percent.

The layers used in the lenses of the invention are applied to, or printed on, the lens surface by any convenient method. In a preferred method, a thermoplastic optical mold, made from any suitable material including, without limitation, cyclic polyolefins and polyolefins such as polypropylene or polystyrene resin is used. The color layers, such as the translucent base layer, are deposited onto the desired portion of the molding surface of the mold. By “molding surface” is meant the surface of a mold or mold half used to form a surface of a lens. The deposition preferably is carried out so that the outermost color layer on the lens surface will be the translucent base layer. Preferably, the deposition is carried out by pad printing as follows.

A metal plate, preferably made from steel and more preferably from stainless steel, is covered with a photo resist material that is capable of becoming water insoluble once cured. The pattern of the color layer is selected or designed and then reduced to the desired size using any of a number of techniques such as photographic techniques, placed over the metal plate, and the photo resist material is cured.

Following the pattern, the plate is subsequently washed with an aqueous solution and the resulting image is etched into the plate to a suitable depth, for example about 20 microns. A colorant containing a binding polymer, solvent, and pigment or dye is then deposited onto the pattern to fill the depressions with colorant. A silicon pad of a geometry suitable for use in printing on the surface and varying hardness, generally about 1 to about 10, is pressed against the image on the plate to remove the colorant and the colorant is then dried slightly by evaporation of the solvent. The pad is then pressed against the molding surface of an optical mold. The mold is degassed for up to 12 hours to remove excess solvents and oxygen after which the mold is filled with lens material. A complementary mold half is then used to complete the mold assembly and the mold assembly is exposed to conditions suitable to cure the lens material used. Such conditions are well known in the art and will depend upon the lens material selected. Once curing is completed and the lens is released from the mold, it is equilibrated in a buffered saline solution.

What is claimed is:

1. A contact lens, comprising at least one surface comprising a base layer having a clear central zone and a translucent color zone and one or more additional color layers selected from the group consisting essentially of a second translucent color layer, an opaque color layer, or a combination thereof, wherein each of the one or more additional color layers has a clear central zone and a color zone.

2. The lens of claim 1, wherein color zones of the base layer and additional color layers cover greater than about 85 percent of the area of an iris.

3. The lens of claim 1, wherein the base layer and the additional color layers cover greater than about 90 percent of the area of an iris.

4. The lens of claim 2, wherein the color zone of the base layer covers about 85 to about 99 percent of the area of the iris and the color zones of the one or more additional color layers cover about 40 to about 70 percent of the area of the iris.

5. The lens of claim 3, wherein the color zone of the base layer covers about 85 to about 99 percent of the area of the iris and the color zones of the one or more additional color layers cover about 40 to about 70 percent of the area of the iris.

6. The lens of claim 1, wherein the base layer color zone is of a uniform color.

7. The lens of claim 6, wherein the base layer color zone further comprises clear or colored shapes selected from the group consisting of circles, ovals, triangles, lines, striae, feather-like shapes, and combinations thereof.

8. The lens of claim 2, wherein the base layer color zone is of a uniform color.

9. The lens of claim 8, wherein the base layer color zone further comprises clear or colored shapes selected from the group consisting of circles, ovals, triangles, lines, striae, feather-like shapes, and combinations thereof.

10. The lens of claim 8, comprising the base color layer and two opaque color layers.

11. The lens of claim 1, wherein the base layer color zone is of a radially gradient color.

12. The lens of claim 11, wherein the base layer color zone further comprises clear or colored shapes selected from the group consisting of circles, ovals, triangles, lines, striae, feather-like shapes, and combinations thereof.

13. The lens of claim 2, wherein the base layer color zone is of a radially gradient color.

14. The lens of claim 13, wherein the base layer color zone further comprises clear or colored shapes selected from the group consisting of circles, ovals, triangles, lines, striae, feather-like shapes, and combinations thereof.

15. The lens of claim 1, further comprising a clear pre-polymer layer.

16. The lens of claim 1, wherein the lens further comprises acquafilcon, etafilcon, genfilcon or lenefilcon.

17. The lens of claim 6, 7, 8, 9, 11, 12, or 13, wherein the additional color layers comprise one or more second translucent color layers each having a color zone of uniform color.

18. The lens of claim 17, wherein the color zones of the one or more second translucent color layers further comprise clear or colored shapes selected from the group consisting of circles, ovals, triangles, lines, striae, feather-like shapes, and combinations thereof.

19. The lens of claim 6, 7, 8, 9, 11, 12, or 13, wherein the additional color layers comprise one or more second translucent color layers each having a color zone that is of a radially gradient color.

20. The lens of claim 19, wherein the color zone of the one or more second translucent layers further comprises clear or colored shapes selected from the group consisting of circles, ovals, triangles, lines, striae, feather-like shapes, and combinations thereof

21. The lens of claim 6, 7, 8, 9, 11, 12, 13, 17, 18, 19 20, wherein the additional color layers comprises one or more opaque color layers each having a color zone that is of a uniform color.

22. The lens of claim 21, wherein the color zones of the one or more opaque color layers further comprises clear or colored shapes selected from the group consisting of circles, ovals, triangles, lines, striae, feather-like shapes, and combinations thereof.

23. The lens of claim 6, 7, 8, 9, 11, 12, 13, 17, 18, 19 20, wherein the additional color layers comprise one or more opaque color layers each having a color zone that is of a radially gradient color.

24. The lens of claim 23, wherein the one or more opaque layer color zone further comprises clear or colored shapes selected from the group consisting of circles, ovals, triangles, lines, striae, feather-like shapes, and combinations thereof.

25. A method for manufacturing a tinted contact lens, comprising the step of: depositing onto a surface of a lens a base layer having a clear central zone and a translucent color zone and one or more additional color layers selected from the group consisting of a second translucent color zone, an opaque color layer, or a combination thereof, wherein each of the one or more additional color layers has a clear central zone and a color zone.

26. A method for manufacturing a tinted contact lens, comprising the steps of: depositing onto a molding surface of a lens mold a base layer having a clear central zone and a translucent color zone and one or more additional color layers selected from the group consisting of a second translucent color layer, an opaque color layers, or a combination thereof, wherein each of the additional color layers has a clear central zone and a color zone.

27. The method of claims 25 or 26, wherein the color zones of the color layers of the lens cover greater than about 85 percent of the area of an iris.

28. The method of claims 25 or 26, wherein the color zones of the color layers of the lens cover greater than about 90 percent of the area of an iris.

29. The lens of claim 27, wherein the color zone of the base layer covers about 85 to about 99 percent of the area of the iris and the color zones of the additional color layers cover about 40 to about 70 percent of the area of the iris.

30. The lens of claim 28, wherein the color zone of the base layer covers about 85 to about 99 percent of the area of the iris and the total coverage imparted by the color zones of the additional color layers is about 40 to about 70 percent of the area of the iris.

31. The method of claim 26, wherein the translucent base layer is deposited onto the molding surface before any of the other color layers are deposited.

32. The method of claims 26 or 31, wherein deposition is carried out by pad printing.
